(19) United States
(12) Patent Application Publication
(10) Pub. No.: US 2006/0132654 A1
(43) Pub. Date: Jun. 22, 2006

(54) Computer system storing display environment

(75) Inventors: Han-sung Kim, Incheon City (KR); Hyung-gu Park, Yongin-si (KR); Dong-hun Lee, Yangju-gun (KR); Seon-Hwa Min, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronic Co., Ltd.

(21) Appl. No.: 11/258,289

(22) Filed: Oct. 26, 2005

(30) Foreign Application Priority Data
Dec. 16, 2004 (KR) 2004-107090

(51) Int. Cl. H04N 5/50

(52) U.S. Cl. 348/569

(57) ABSTRACT

Disclosed is a computer system having a computer and a monitor connected to the computer for displaying an image from the computer thereon. The monitor has an input unit for each user to set and select the display environment, a profile storing unit for storing therein the display environment information set by each user, and a monitor control unit for storing the display environment information set by each user through manipulation of the input unit in the profile storing unit and outputting the display environment information of each user to the computer. The computer has a storage unit for storing the display environment information by each user therein, and a computer control unit for storing the display environment information input by each user from the monitor in the storage unit.

### CROSS-REFERENCE TO RELATED APPLICATION

This application claims the benefit of Korean Patent Application No. 2004-0107090, filed on Dec. 16, 2004, in the Korean Intellectual Property Office, the entire disclosure of which is hereby incorporated by reference.

### BACKGROUND OF INVENTION

1. Field of Invention

The present invention relates to a computer system comprising a display monitor connected to a computer. More particularly, the present invention relates to a computer system capable of storing display environment information input by each user and displaying an optimal image picture meeting the user's preference after quickly obtaining user information.

2. Description of the Related Art

A conventional computer system comprises a computer providing an image signal, and a monitor connected to the computer, displaying thereon an image picture according to the image signal from the computer.

In the conventional computer system, the monitor comprises a key input unit provided on the monitor body, being capable of changing display environment settings covering brightness, color, contrast, and the like of the image picture displayed, through manipulation of the key input unit.

In the conventional computer system including the monitor described above, to change the display environment settings, a user manipulates the key input unit and sets the display environment according to a preferred brightness setting, color setting, contrast setting, and the like with desired values in a setting menu (for example, an on screen display (OSD) menu) to set up the display environment. The monitor stores the set display environment information in a predetermined memory and displays an image picture according to the display environment information. The computer system retains the set display environment information and displays the image picture on this basis until the display environment information is changed by the user.

However, it is not unusual for a single computer system to be used by multiple users, and the display environments preferred by each of the users may be different.

In the case where a computer system is used by multiple users, each user has to readjust the display environment of an image displayed whenever he or she uses the computer system, by accessing the setting menu (for example, OSD menu) to set up the display environment if the display environment is not satisfactory, into his or her preferred display environment, which is inconvenient to the users when using the computer system.

### SUMMARY OF THE INVENTION

Accordingly, it is an aspect of the present invention to provide a computer system capable of storing display environment information by each user and displaying an optimal image picture meeting the user's preference after quickly obtaining user information.

Additional aspects and advantages of the present invention will be set forth in part in the following description.

The foregoing and other aspects of the present invention are also achieved by providing a computer system comprising a computer and a monitor connected to the computer for displaying an image from the computer thereon, wherein the monitor comprises an input unit for setting and selecting a display environment for each user, a profile storing unit for storing therein the display environment information set by each user, and a monitor control unit for storing in the profile storing unit the display environment information set by each user through manipulation of the input unit and outputting the display environment information of each user to the computer. The computer comprises a storage unit for storing the display environment information of each user therein, and a computer control unit for storing in the storage unit the display environment information of each user input from the monitor.

According to an aspect of the present invention, the monitor comprises an image signal processing unit to process an image signal from the computer, and the monitor control unit outputs the user information to the computer, when the user information is selected through the input unit, and controls the image signal processing unit to process the image signal according to the display environment information corresponding to the user information based on the display environment information stored in the profile storing unit.

According to an aspect of the present invention, the computer comprises a graphic card for output of the image signal to the monitor, and the computer control unit controls the graphic card to output the image signal according to the display environment information corresponding to the user information input from the monitor, based on the display environment information stored in the storage unit.

According to an aspect of the present invention, the input unit comprises an OSD generating unit for providing a display environment setting menu to set up the display environment and a user selecting menu to select the user information, and a key input unit for entering key inputs by a user.

According to an aspect of the present invention, the monitor control unit stores the display environment information set up in the display environment setting menu through manipulation by the key input unit in the profile storing unit by each user. The monitor control unit also controls the image signal processing unit to process the image signal according to the display environment information corresponding to the user information selected in the user selecting menu from among the display environment information of each user, and outputs the display environment information of each user and the selected user information to the computer.

According to an aspect of the present invention, the input unit comprises a hot key to select the user information.

According to an aspect of the present invention, the computer comprises a user setting unit to select the user information, and the computer control unit controls the graphic card so as to output the user information. When the user information is selected through manipulation of the user setting unit and outputs the image signal according to the display environment information corresponding to the selected user information to the monitor.

According to an aspect of the present invention, the monitor control unit controls the image signal processing unit to process the image signal according to the display environment information corresponding to the user information when the user information is input from the computer.

According to an aspect of the present invention, the user setting unit further comprises a function to set up the display environment information, and the computer control unit controls the graphic card so as to store the display environment information set up through manipulation, of the user setting unit in the storage unit for each user. The computer control unit outputs the image signal according to the display environment information corresponding to the selected user information from among the display environment information for each user, and outputs the display environment information for each user and the selected user information to the monitor.

According to an aspect of the present invention, the monitor control unit stores the display environment information input by each user from the computer in the profile storing unit, and controls the image signal processing unit so as to process the image signal according to the display environment information corresponding to the user information input from the computer.

According to an aspect of the present invention, the user setting unit comprises predetermined PC control software to set and select the display environment.

According to an aspect of the present invention, the display environment information comprises at least one of brightness information, contrast information, and resolution information.

### BRIEF DESCRIPTION OF THE DRAWINGS

The above and other aspects and advantages of the present invention will become apparent and more readily appreciated from the following description of the exemplary embodiments, taken in conjunction with the accompanying drawings of which:

FIG. 1 is a control block diagram of a computer system according to an embodiment of the present invention;

FIG. 2 is a control flow chart of a computer system according an embodiment of the present invention;

FIG. 3 is a partial control flow chart of a computer system according to an embodiment of the present invention; and

FIG. 4 illustrates a display environment setting menu displayed on the computer system an embodiment of the present invention.

Throughout the drawings, it should be understood that like reference numerals refer to like features, structures and elements.

### DETAILED DESCRIPTION OF EXEMPLARY EMBODIMENTS

Reference will now be made in detail to the embodiments of the present invention, examples of which are illustrated in the accompanying drawings, wherein like reference numerals refer to like elements throughout.

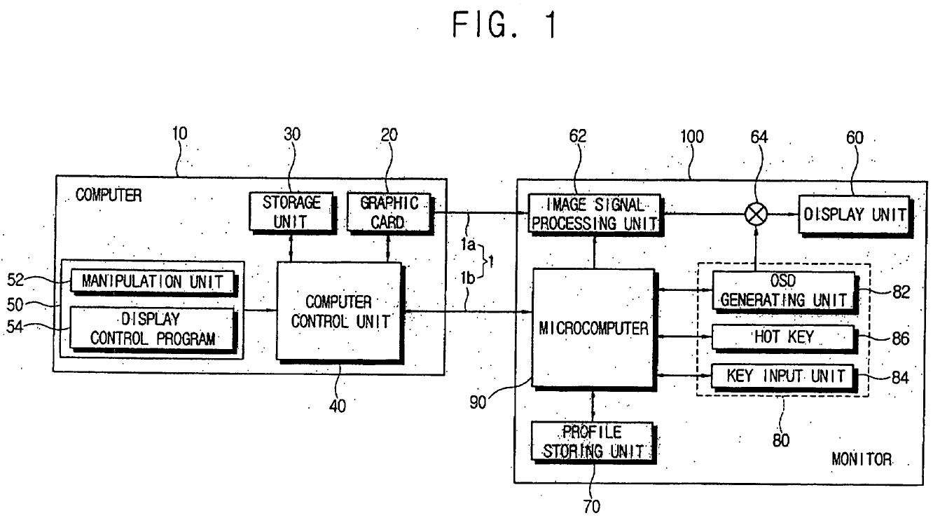

FIG. 1 is a control block diagram of a computer system according to an embodiment of the present invention. As illustrated, the computer system according to the present invention comprises a computer 10, and a monitor 100 connected to the computer 10 through a communication line, displaying thereon an image from the computer 10.

The communication line 1 is connectable through various communication ports such as a D-sub communication port (not shown) or a digital video interface (DVI) communication port (not shown).

The monitor 100 comprises a display unit 60, an image signal processing unit 62 for processing an image signal from the computer 10 so as to be displayable on the display unit 60, a profile storing unit 70 for storing display environment information by each user, an input unit 80 to set and select an display environment by each user, and a microcomputer 90 for storing display environment information set by each user through manipulation of the input unit 80. The microcomputer 90 controls the image signal processing unit 62 according to the display environment information corresponding to the user information selected through the input unit 80 and outputs the display environment information for each user and the selected user information to the computer 10. Hereinafter, the microcomputer 90 is also referred to as a monitor control unit.

The computer 10 comprises a graphic card 20 for outputting an image signal to the monitor 100, a storage unit 30 for storing therein display environment information for each user, and a computer control unit 40 for storing display environment information input by each user from the monitor 100 in the storage unit 30. The computer control unit 40 also controls the graphic card 20 according to the display environment information corresponding to the user information inputted from the monitor 100.

It is preferred that communication between the microcomputer 90 and the computer control unit 40 is via a direct digital control (DDC) communication 1b line, which transmits and receives data according to a predetermined protocol, through a communication line 1 interconnecting them, comprising a SDA bus and a SCL bus.

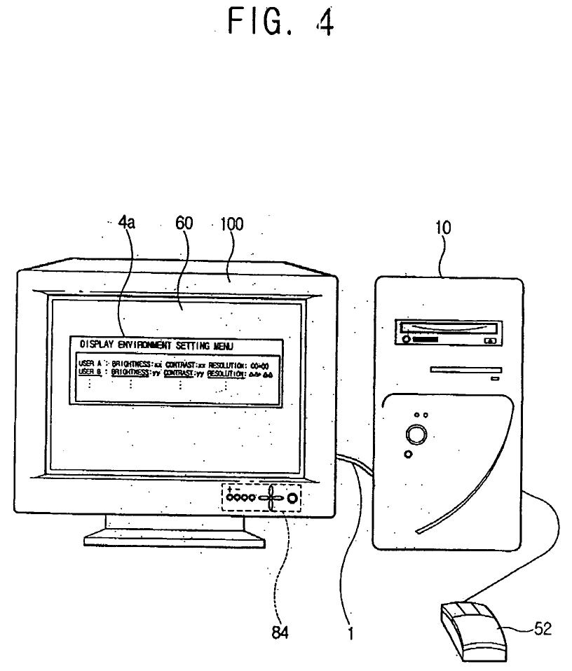

The input unit 80 refers to an input function part to set and select display environment by each user, comprising an OSD generating unit 82 for providing a display environment setting menu to set up a display environment and a user selecting menu to select user information, and a key input unit 84 for receiving a key input from a user, including a plus (+) key and a minus (−) key to manipulate the user selecting menu. As illustrated in FIG. 4, the key input unit 84 is preferably provided in the lower end of the display unit 60 in front of the monitor 100 body. It is also preferred that the key input unit 80 further comprises a hot key 86 (shown in FIG. 1) to select the user information.

Referring back to FIG. 1, the profile storing unit 70 stores display environment information for each user when set relative to multiple users, as controlled by the microcomputer 90. It is preferred that the display environment information comprises at least one of brightness information, contrast information, and resolution information.

The microcomputer 90 controls the OSD generating unit 82 so that the display environment setting menu 41 as illustrated in FIG. 4 is displayed on the display unit 60 when the display environment setting function is selected through manipulation of the key input unit 84. The microcomputer 90 stores the display environment information set up in the display environment setting menu 4a through manipulation of the key input unit 84 in the profile storing unit 70 and outputs the display environment information for each user stored in the profile storing unit 70.

In addition, when a user selecting function is selected through manipulation of the key input unit 84, the microcomputer 90 controls the OSD generating unit 82 and displays the user selecting menu on the display unit 60. When user information is selected in the user selecting menu through manipulation of the key input unit 84, the microcomputer 90 outputs the user information to the computer 10 and controls the image signal processing unit 62 to process the image signal according to the display environment information corresponding to the selected user information. Alternatively, instead of displaying the user selecting menu, the user information can be selected directly through manipulation of the hot key 86.

The storage unit 30 is a predetermined memory unit provided in the computer 10 for storing therein the display environment information input by each user from the memory as controlled by the computer control unit 40, which will now be described later in more detail.

The computer control unit 40 stores the display environment information input by each user from the microcomputer 90 of the monitor 100 in the storage unit 30. When the user information is input from the microcomputer 90, the computer control unit 40 controls the graphic card 20 so as to output an image signal according to the display environment information corresponding to the user information as based on the display environment information for each user stored in the storage unit 30.

With this configuration, the computer system according to an embodiment of the present invention sets up the display environment information for each user-by manipulating the input unit 80 of the monitor 100, and stores this information both in the monitor 100 and the computer 10. When the user selects his or her own user information by manipulating the input unit 80 of the monitor 100, a display environment of the monitor 100 and an environment of the graphic card 20 of the computer 10 are ,set according to the display environment information already stored, which corresponds to the user information. Accordingly, the computer system according to an embodiment of the present invention may provide an optimal image picture meeting the concerned user's preferences through the quick selection of user information.

It is preferred that the computer 10 further comprises a user setting unit 50 to set the display information for each user and to select user information.

The user setting unit 50 comprises a display control program 54 providing a predetermined setting menu to select display environment information and user information, as predetermined by PC control software to set the display environment for each user and select user information, and a manipulation unit 52 for input manipulation corresponding to an input by a user. As illustrated in FIG. 4, the manipulation unit 52 may be provided as a mouse or a keyboard (not shown).

When a function to set the display environment settings or select a user is selected through manipulation by the manipulation unit 52, the computer control unit 40 executes the display control program 54 to thereby display the predetermined setting menu on the display unit 60 of the monitor 100. Also, the computer control unit 40 stores the display environment information set in the predetermined setting menu through manipulation by the manipulation unit 52 in the storage unit 30 for each user and outputs the display environment information for each user stored in the storage unit 30 to the monitor 100.

When user information is selected in the predetermined setting menu of the key input unit 84 through manipulation by the manipulation unit 52, the computer control unit 40 also controls the graphic card 20 to thereby output an image signal according to the display environment information corresponding to the selected user information based on the information stored in the storage unit 30.

The microcomputer 90 stores display environment information input by each user from the computer control unit 40 of the computer in the profile storing unit 70. Also, when user information is input from the computer control unit 40, the microcomputer 90 controls the image signal processing unit 52 to process an image signal according to the display environment information corresponding to the user information based on the display environment information for each user stored in the profile storing unit 70.

In the computer system with this configuration according to an embodiment of the present invention, it is possible to change an environment of the graphic card 20 of the computer 10 and a display environment of the monitor 100 according to the display environment information corresponding to the user information. A user stores the display environment information for each user and selects his or her own user information while the user is using the computer system, by manipulating the user setting unit 50 of the computer 10, which the user is accustomed to using instead of manipulating the input unit 80 of the monitor 100. Accordingly, the computer system according to an embodiment of the present invention may provide an optimal image picture meeting the concerned user's preferences by quickly selecting user information.

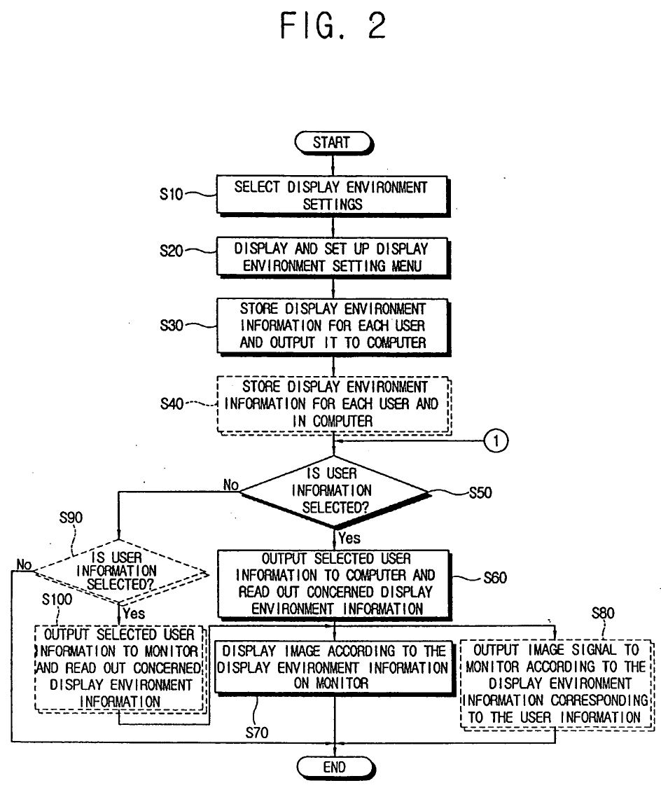

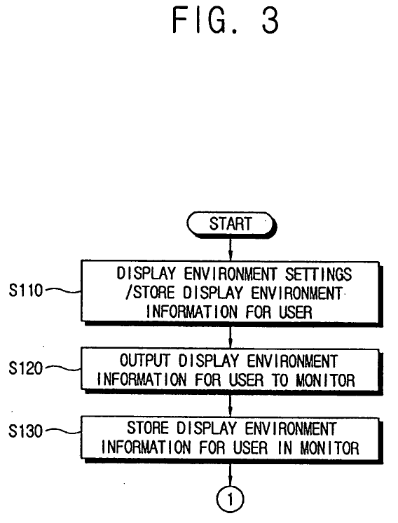

A flowchart of the computer system with this configuration will be described with reference to FIGS. 2 and 3.

The computer 10 supplies the image signal corresponding to the preset display environment information to the monitor 100, and the monitor 100 performs a general display operation, i.e., processes the image signal supplied by the computer 10 according to the preset display environment information to display it. Referring to FIG. 2, which depicts a flowchart for describing a method of setting a display according to a first exemplary embodiment, the microcomputer 90 controls an OSD generating unit 82 to display a display environment setting menu on the display unit 60 when the display environment setting function is selected through manipulation of the key input unit 84 at operation S10, and each user sets up his or her own display environment information at operation S20. The microcomputer 90 stores the display environment information set by each user in the display environment setting menu in the profile storing unit 70, and outputs the display environment information for each user to the computer 10 at operation S30. According to this, the computer control unit 40 stores the display environment information input by each user from the monitor 100 in the storage unit 30 at operation S40.

Thereafter, the microcomputer 90 determines whether the user information is selected either by the user selecting via the menu or through manipulation of the hot key at operation S50. When the user information is selected by a user, the microcomputer 90 outputs the selected user information to the computer 10 and reads out the display environment information corresponding to the selected user information from among display environment information (operation S60) stored by each user. The microcomputer 90 controls the image signal processing unit 62 so as to display the image signal processed according to the read out display environment information at operation S70. The monitor 100 changes the display environment according to the display environment information corresponding to the selected user information so as to display the image signal supplied by the computer 10 as an image suitable for a user's demand. At this time, the computer control unit 40 controls the graphic card 20 concurrently with operation S70 and outputs the image signal for display according to the display environment information corresponding to the user information input from the monitor 100 from among the display environment information stored in the storage unit 30 by each user at operation S80. As the image signal supplied by the computer 10 is also affected by the display environment information corresponding to the selected user information, the monitor 100 may display an optical image suitable for a user's demand. Then, the computer 10 supplies the image signal according to the display environment information corresponding to the selected user information, and the monitor 100 processes the image signal supplied by computer 10 according to the display environment information corresponding to the selected user information to display it.

At step S50, where the user information is not selected in the monitor 100, the computer control unit 40 executes the display control program 54 to determine whether the user information is selected in the predetermined setting menu at operation S90. At step S90, where the user information is not selected, the display environment information is not changed. At this time, the computer 10 supplies the image signal according to the preset display environment information to the monitor 100, and the monitor 100 performs a general display operation, i.e., processes the image signal supplied by the computer 10 according to the preset display environment information to display it.

At step S90, where the user information is selected, the computer control unit 40 outputs the selected user information to the monitor 100 and reads out the display environment information corresponding to the selected user information from among the display environment information stored in the storage unit 30 by each user at operation S100. The computer control unit 40 controls the graphic card 20 and outputs the image signal according to the read out display environment information at operation S80. At this time, the microcomputer 90 controls the image signal processing unit 62 concurrently with operation S80 and displays the image signal processed according to the user information input from the computer 10 from among the display environment information stored by each user at operation S70.

In the first exemplary embodiment described above, where the user information is not selected in the monitor 100, a determination as to whether the user information is selected in the computer 10 is by way of example. In the computer system according to another embodiment of the present invention, when user information is selected through any one of the monitor 100 and the computer 10, the user information is mutually transmitted and received and both of the computer 10 and the monitor 100 are set with regard to the display environment corresponding to the selected user information.

Referring to FIG. 3, which is a flowchart for describing the display setting method according to a second exemplary embodiment of the present invention. When a function to set up display environment or select a user is selected through manipulation of the manipulation unit 52, the computer control unit 40 executes the display control program 54 to thereby display a predetermined setting menu on the display unit 60 of the monitor 100. The computer control unit 40 stores the display environment information set in the predetermined setting menu through manipulation of the manipulation unit in the storage unit 30 by a user at operation S110. Also, the computer control unit 40 outputs the display environment information stored by each user in the storage unit 30 to the monitor 100 at operation S120. Accordingly, the microcomputer 90 of the monitor 100 stores the display environment information input by each user from the computer 10 in the profile storing unit 70 at operation S130. According to this, the display environment information for each user is stored both in the monitor 100 and the computer 10. Thereafter, the computer control unit 40 progresses to operation \textcircled{1} of FIG. 2 and repeats operations S50 to S100.

Through these processes, the computer system sets the display environment information for each user when the user manipulates any one of the user setting unit 50 of the computer 10 and the input unit 80 of the monitor 100. The display environment information set by each user is jointly shared and stored through communication between the computer 10 and the monitor 100. Accordingly, where a user selects his or her own user information while a user is using the computer system, a display environment of the graphic card 20 of the computer 10 and a display environment of the monitor 100 are changed according to the display environment information corresponding to the user information.

Where a computer system according to the present invention is used by multiple users, the inconvenience resulting from having to readjust the display environment information of a monitor to the display environment preferred by him or her whenever each user uses the computer system is resolved and an optimal image picture meeting the concerned user's preferences can be provided to the user with a quick selection of user information.

As described above, according to embodiments of the present invention, there may be provided a computer system capable of displaying an optimal image picture meeting each user's preferences with a quick selection of user information, by storing the display environment information by each user.

Although several embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A computer system for displaying an image comprising:
a computer;
a monitor connected to the computer for displaying an image from the computer thereon; wherein the monitor comprises:
an input unit for each user to set and select display environment information;
a profile storing unit for storing therein the set display environment information for each user; and
a monitor control unit for storing the display environment information for each user set by each user through manipulation of the input unit in the profile storing unit and outputting the display environment information for each user to the computer; and
wherein the computer comprises:
a storage unit for storing the display environment information for each user therein, and a computer control unit for storing the display environment information for each user input from the monitor in the storage unit.

2. The computer system according to claim 1, wherein the monitor comprises an image signal processing unit to process an image signal from the computer; and
wherein the monitor control unit outputs user information, when the user information is selected through the input unit, to the computer and controls the image signal processing unit to process the image signal according to the display environment information corresponding to the user information based on the user information stored in the profile storing unit.

3. The computer system according to claim 2, wherein the computer comprises a graphic card for outputting the image signal to the monitor, and
wherein the computer control unit controls the graphic card so as to output the image signal according to the display environment information corresponding to the user information, when the user information is input from the monitor based on the user information stored in the storage unit.

4. The computer system according to claim 3, wherein the input unit comprises an OSD generating unit for providing a display environment setting menu to set up the display environment and a user selecting menu to select the user information, and a key input unit for key input by a user.

5. The computer system according to claim 4, wherein the monitor control unit stores the display environment information for each user set up in the display environment setting menu through manipulation by the key input unit in the profile storing unit, and controls the image signal processing unit to process the image signal according to the display environment information corresponding to the user information selected by each user in the user selecting menu from among the display environment information for each user, and outputs the display environment information for each user and the selected user information to the computer.

6. The computer system according to claim 5, wherein the input unit comprises a hot key to select the user information.

7. The computer system according to claim 5, wherein the computer comprises a user setting unit to select the user information, and
wherein the computer control unit outputs the user information to the monitor, and controls the graphic card so as to outputs the image signal according to the display environment information corresponding to the selected user information, when the user information is selected through manipulation by the use setting unit.

8. The computer system according to claim 7, wherein the monitor control unit controls the image signal processing unit to process the image signal according to the display environment information corresponding to the user information input from the computer.

9. The computer system according to claim 8, wherein the user setting unit further comprises a function to set the display information, and
wherein the computer control unit stores the display environment information for each user set up through manipulation by the user setting unit in the storage unit, controls the graphic card so as to outputs the image signal according to the display environment information corresponding to the selected user information from among the display environment information for each user, and outputs the display environment information for each user and the selected user information to the monitor.

10. The computer system according to claim 9, wherein the monitor control unit stores the display environment information for each user input from the computer in the profile storing unit, and controls the image signal processing unit so as to process the image signal according to the display environment information corresponding to the user information input from the computer.

11. The computer system according to claim 10, wherein the user setting unit comprises a predetermined PC control software to set and select the display environment.

12. The computer system according to claim 1, wherein the display environment information comprises at least one of brightness information, contrast information, and resolution information.

13. The computer system according to claim 2, wherein the display environment information comprises at least one of brightness information, contrast information, and resolution information.

14. The computer system according to claim 3, wherein the display environment information comprises at least one of brightness information, contrast information, and resolution information.

15. The computer system according to claim 4, wherein the display environment information comprises at least one of brightness information, contrast information, and resolution information.

16. The computer system according to claim 5, wherein the display environment information comprises at least one of brightness information, contrast information, and resolution information.

17. The computer system according to claim 6, wherein the display environment information comprises at least one of brightness information, contrast information, and resolution information.

18. The computer system according to claim 7, wherein the display environment information comprises at least one of brightness information, contrast information, and resolution information.

19. The computer system according to claim 8, wherein the display environment information comprises at least one of brightness information, contrast information, and resolution information.

20. The computer system according to claim 9, wherein the display environment information comprises at least one of brightness information, contrast information, and resolution information.

21. The computer system according to claim 10, wherein the display environment information comprises at least one of brightness information, contrast information, and resolution information.

22. The computer system according to claim 11, wherein the display environment information comprises at least one of brightness information, contrast information, and resolution information.
